(19) United States
(12) Patent Application Publication
(10) Pub. No.: US 2010/0171239 A1
(43) Pub. Date: Jul. 8, 2010

(54) Systems and method for concrete forming

(76) Inventor: Dwight D. Ingalls, Oconomowoc, WI (US)

Correspondence Address: RYAN KROMHOLZ & MANION, S.C., POST OFFICE BOX 26618, MILWAUKEE, WI, 53226, US

(21) Appl. No.: 12/657,078

(22) Filed: Jan. 13, 2010

(51) Int. Cl. B29C 39/36; B28B 7/28

(52) U.S. Cl. 264/334; 249/175

(57) ABSTRACT

Systems and methods according to the present invention provide casting molds having improved separability from cured molding material. A first system and method employ an extraction rim which provides a clamping surface to be used in conjunction with an extraction bridge which straddles a mold. A second system and method employ a reusable, expandable molding mandrel that may be used to form voids in a casting. A third system and method employ both the extraction rim and the reusable, expandable molding mandrel.

### BACKGROUND OF THE INVENTION

Embodiments of the present invention relate generally to casting or molding, and more particularly to molds and related systems having improved separability from cured castings.

In the art of product casting, especially when using a material such as concrete, the removal or separation of a mold from a cured casting can be a difficult task when care is taken to avoid damage to the casting or mold. While various prior attempts have been made at improving mold-casting separability, there remains significant room for improvement, especially related to void-forming molds.

For instance, some prior devices provide handles to improve the manual separation process. Generally, the handles are provided at discrete locations, usually two locations, on the inside of the mold. Two types of handles have been employed on prior molds in an attempt to ease extraction. First, individual metal grip or pull handles have been either adhered or otherwise fastened to the mold wall. While the metal handles are substantially rigid, they are generally shaped so as to hamper any sort of use in conjunction with a mechanical separation aid, such as a clamping member. Further, due to the limited area of force application by the handle to the mold, a stress riser is created where the handles are joined to the mold, thereby risking damage to the mold, such as cracking, or at least decreased mold life due to sometimes severe flexing of the mold housing. Second, individual wood handles have been either adhered or otherwise fastened to the mold wall. The discrete wood handles, not being as rigid as the metal handles, tend to flex when the required extraction force is applied thereto. Thus, the force application to the handle can be unpredictable. Further, as with the metal handles, due to the limited area of force application by the handle, a stress riser is created where the handles are joined to the mold, thereby risking damage to the mold, such as cracking, or at least decreased mold life due to sometimes flexing of the mold housing. Even where handles have been generally effective for removing molds, the molds, especially fiberglass molds, may be prone to chipping at the perimeter edge thereof.

Accordingly, the art of molding would benefit from void-forming molds or components thereof that have improved extraction or separation and reinforcement characteristics.

### SUMMARY OF THE INVENTION

Embodiments of the present invention provide void-forming molds or components thereof that have improved extraction or separation characteristics.

An embodiment of a mold according to the present invention includes a housing formed partially around a cavity. The housing has at least one working surface adapted to receive a molding material. The working surface defines a mold perimeter. Extending radially inward from the mold perimeter is an extraction rim.

According to an aspect of an embodiment of a mold according to the present invention, the extraction rim comprises a substantially planar plate. The plate may completely surround at least one aperture formed therethrough.

According to another aspect of an embodiment of a mold according to the present invention, a mold may further include a void-forming mandrel coupled to the housing adjacent to and extending away from one of the at least one working surface. The void-forming mandrel, which may include a radially expansible member, may be detachably coupled to the housing. The radially expansible member may include an elastomeric bushing having a predetermined hardness, such as about 30 Shore.

An embodiment of a mold kit according to the present invention includes an embodiment of a mold according to the present invention and a first extraction bridge adapted to span a first portion of the mold perimeter. The mold kit may further include at least one clamping member, which may comprise a support beam, a first jaw member fixed to one end of the support beam, a second jaw member slidably disposed on the support beam, and a clamping force applicator disposed at least partially between the first and second jaw members. The clamping force applicator may include a threaded rod extending through one of the jaw members, such as the second jaw member.

According to an aspect of an embodiment of a mold kit according to the present invention, the kit may further include a first clamp contact pad disposed on the first jaw member, wherein all points of the first clamp contact pad are located at a jaw depth that is less than or equal to the maximum width of the extraction rim.

According to an aspect of another embodiment of a mold kit according to the present invention, two extraction bridges may be provided, which may be adapted to span the same or different portions, such as the diameter, of the mold perimeter. The multiple bridges may be adapted to function in an overlapping relationship to each other.

An embodiment of a method of molding according to the present invention includes the steps of providing an embodiment of a mold according to the present invention and providing a mold extraction bridge. Casting material, such as concrete, is disposed on a working surface of the mold. The casting material is allowed to cure, and the mold is removed from the cured casting material using the mold extraction rim and the mold extraction bridge.

According to an aspect of an embodiment of a method of molding according to the present invention, the step of removing the mold from the cured casting material may include the step of spanning a portion of the mold perimeter with the mold extraction bridge. A clamping member may be interfaced to the extraction bridge and the extraction rim, and the extraction rim may be drawn towards the extraction bridge using the clamping member.

### BRIEF DESCRIPTION OF THE DRAWINGS

FIG. 1 is a perspective view of a first embodiment of a mold according to the present invention.

FIG. 2 is a cross-section view taken along line 2-2 of FIG. 1.

FIG. 3 is a cross-section view taken along line 3-3 of FIG. 1.

FIG. 4 is a perspective view of a second embodiment of a mold according to the present invention.

FIG. 5 is a cross section view taken along line 5-5 of FIG. 4.

FIG. 6A is a first perspective view of a third embodiment of a mold according to the present invention.

FIG. 6B is a second perspective view of the embodiment of FIG. 6A.

FIG. 6C is a cross-section view taken along line 6C-6C of FIG. 6A.

FIG. 7 is a perspective view of the mold of FIG. 1 being placed into a casting tray.

FIG. 8 is a perspective view of the mold of FIG. 1 placed at least partially within the casting tray.

FIG. 9 is a perspective view of the arrangement of FIG. 8, further including casting material being poured into the casting tray and at least partially over the mold.

FIG. 10 is a cross-section view taken along line 10-10 of FIG. 9 once the casting tray has been filled to a desired capacity with the casting material.

FIG. 11 is a perspective view of an assembly combination including the mold and cured casting, the assembly combination having been removed from the casting tray.

FIG. 12A is a perspective view of an extraction bridge and clamps being used with the assembly combination of FIG. 11.

FIG. 12B is an elevation view of a preferred embodiment of a clamp as used in FIG. 12A.

FIG. 13 is a first cross-section view taken along line 13-13 of FIG. 12A.

FIG. 14 is a second cross-section view taken along line 13-13 of FIG. 12A.

FIG. 15 is a third cross-section view taken along line 13-13 of FIG. 12A, after removal of the mold, the bridge and the clamps.

FIG. 16 is a perspective view of the mold of FIG. 4 being placed into a casting tray.

FIG. 17 is a perspective view of the mold of FIG. 4 placed at least partially within the casting tray.

FIG. 18A is a first cross-section view taken along line 18-18 of FIG. 17.

FIG. 18B is a second cross-section view taken along line 18-18.

FIG. 19 is a perspective view of the arrangement of FIG. 8, further including casting material being poured into the tray and at least partially over the mold.

FIG. 20 is a first cross-section view taken along line 20-20 of FIG. 19.

FIG. 21 is a second partial cross-section view taken along line 20-20 of FIG. 19.

FIG. 22 is a third cross-section view taken along line 20-20 of FIG. 19 showing the plug being removed.

FIG. 23 is a cross-section view similar to FIG. 14, including a substitution of the mold of FIGS. 6A-6C for the mold of FIG. 1.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

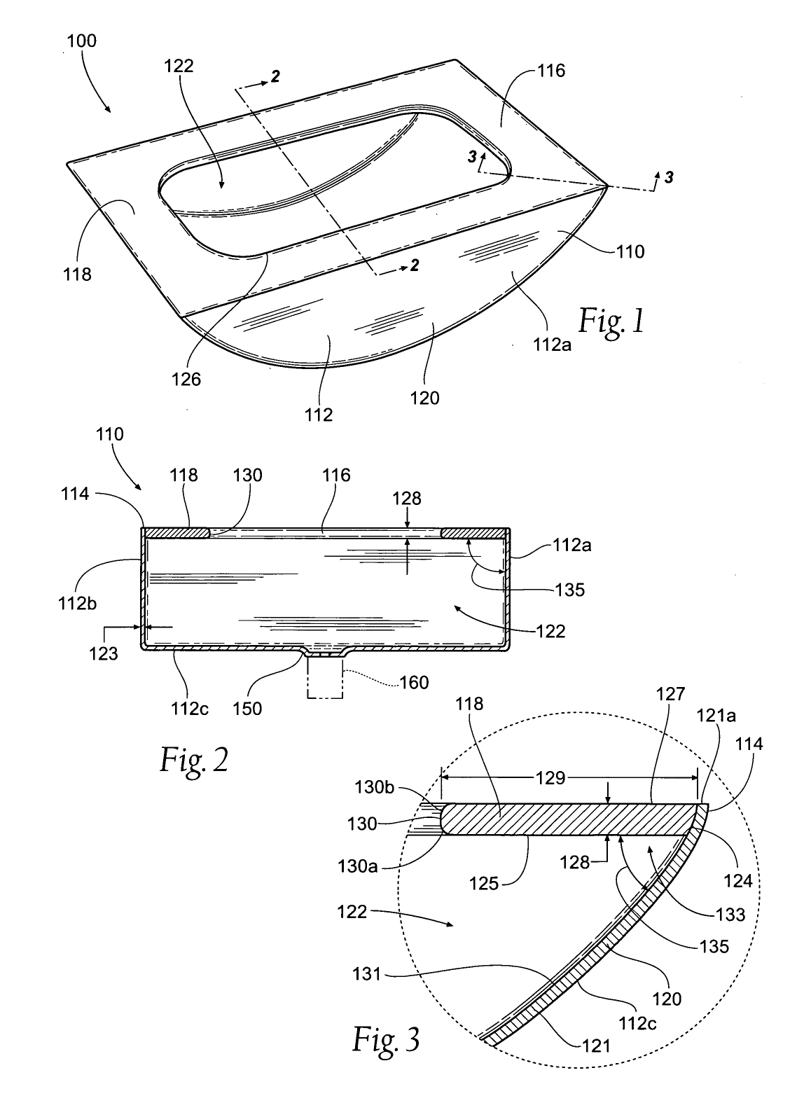

Turning now to the figures, FIGS. 1-3 provide a first embodiment 100 of a mold according to the present invention. The mold 100, in this case a void-forming sink mold, generally comprises a housing 110 which provides at least one working surface 112 adapted to receive a molding material, such as concrete. The embodiment 100 shown provides three working surfaces 112a,112b,112c which define a perimeter edge 114. The housing 110 further includes an extraction rim 116 extending radially inwardly from the perimeter edge 114.

While gaps may be created and reinforced, the extraction rim 116 is preferably disposed adjacent the entire perimeter edge 114. The at least one working surface 112 is preferably provided by a shell 120, which at least partially defines a mold cavity 122. The shell 120 preferably includes at least one wall 121 of a desired thickness 123, such as about 3/16 of an inch, the at least one wall 121 preferably extending to and forming the outer perimeter 114 of the mold 100. While it may be desirable to provide a wall 121 of substantially consistent thickness 123 to aid in predictability of manufacture and performance, such consistency is not required. The wall 121 may extend to a terminal edge 121a. Although shown as rectangular, it is to be understood that the shape of the outer perimeter 114 is not limiting. Further, although shown in a partial “drum” shape, it is to be understood that the shape of the shell 120 is not limiting.

The extraction rim 116 is preferably provided as a plate 118 which is secured to or formed integrally with the shell 120. The plate 118 is preferably provided as a substantially planar plate having an outer perimeter 124, at least one aperture 126, a thickness 128 between an inner surface 125 and an outer surface 127, and a maximum width 129. The plate 118 includes an inner edge 130 provided along each aperture 126. The plate 118, around at least part of one of the at least one aperture 126 is preferably rounded so as to provide comfort and to help prevent injury during handling of the mold 100. For instance, the bottom inside edge 130a or the top inside edge 130b or both, could be rounded. The outer edge 124 is preferably shaped to form a mating relationship with an inner surface 131 of the shell 120. The plate 118 may be formed to be coupled to the shell 120 immediately adjacent to the perimeter 114, thus creating a generally smooth transition from plate 118 to the terminal edge 121a of the shell 120, as shown. This arrangement provides the added benefit of further reinforcement of the shell 120 to help prevent damage to the perimeter 114. The plate inner surface 125 provides a clamping contact surface 133, which is preferably generally a planar surface disposed at a desirable angle 135 with respect to the inner surface 131 and/or working surface 112 of the mold 100, or a tangent thereof. The desirable angle 135 is preferably less than or equal to ninety degrees. At least the outer surface 127 of the plate 118 is preferably coated with a protective coating such as a chemical resistant lacquer primer. Such protective coating helps to prevent absorption of release agents that may be applied to the mold 100 and further has been discovered to aid in the mold/casting separability.

While other materials could be used, the shell 120 is preferably formed from an industrial fiberglass resin material having the working surfaces 112 covered with a gel coat, and the plate 118 is preferably a laminate plywood material of a desired thickness, such as ⅝ of an inch. The shell 120 may also be formed from other materials such as thermoform acrylic or ABS plastic. If formed from these other materials, it may still be desirable to coat the working surfaces 112 with a gel coat.

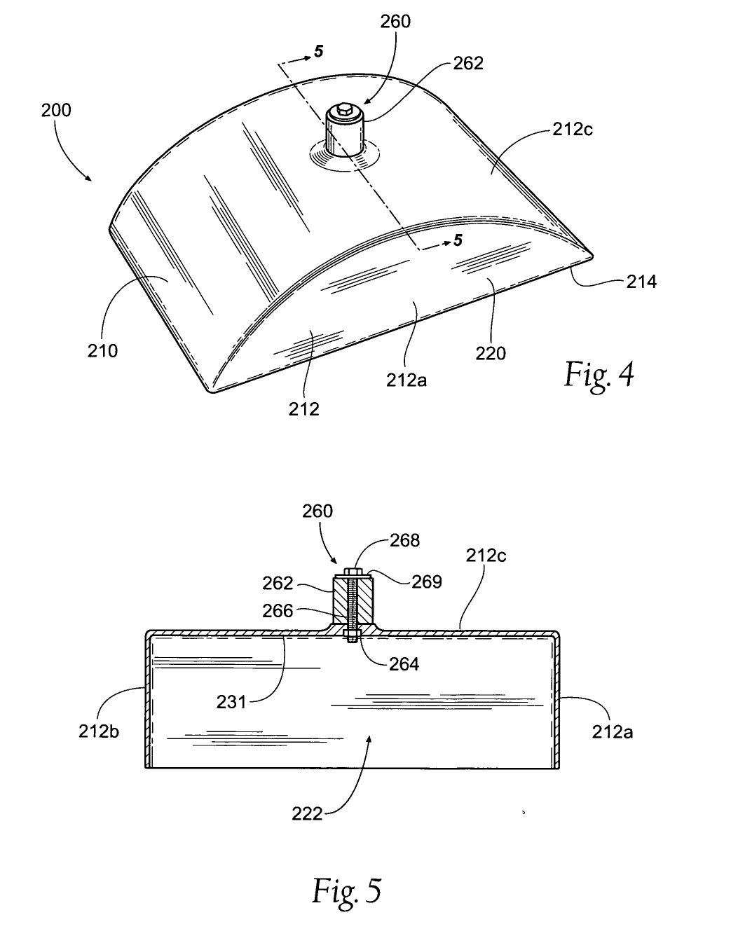

FIGS. 4-5 depict a second embodiment 200 of a mold according to the present invention, wherein like reference numerals refer to similar or identical structure to that of the first embodiment 100. The second embodiment 200 includes a void-forming mandrel 260 which extends outward from a working surface 212c of the mold 200. The mandrel 260 is preferably a longitudinal body that is expandable in one or more radial directions.

For instance, the mandrel 260 may include an elastomeric bushing 262 that is removably coupled to the mold shell 220. The elastomeric bushing 262 has a desired hardness, such as less than 75 Shore and more preferably less than 50 Shore. The elastomeric bushing 262 is preferably formed from molded polyurethane rubber having a desired hardness, such as about 30 Shore. A threaded receiver nut 264 may cooperate with a threaded bolt 266 inserted through the bushing 262 to retain the mandrel 260 in an abutting relationship to the working surface 212c. The receiver nut 264 may be adhered to or formed integrally with the mold shell 220, or it may be provided as a separate component to rest against the inner surface 231 of the shell 220. It is to be understood that the bolt 266 and nut 264 may be transposed, such that head 268 of the bolt 266 is disposed against the inner surface 231 of the shell 220 and the nut 264 rests against a force distributing mechanism, such as a flat washer 269 or other rigid plate member. The operation of the mandrel 260 will be explained in further detail with reference to the second method embodiment below.

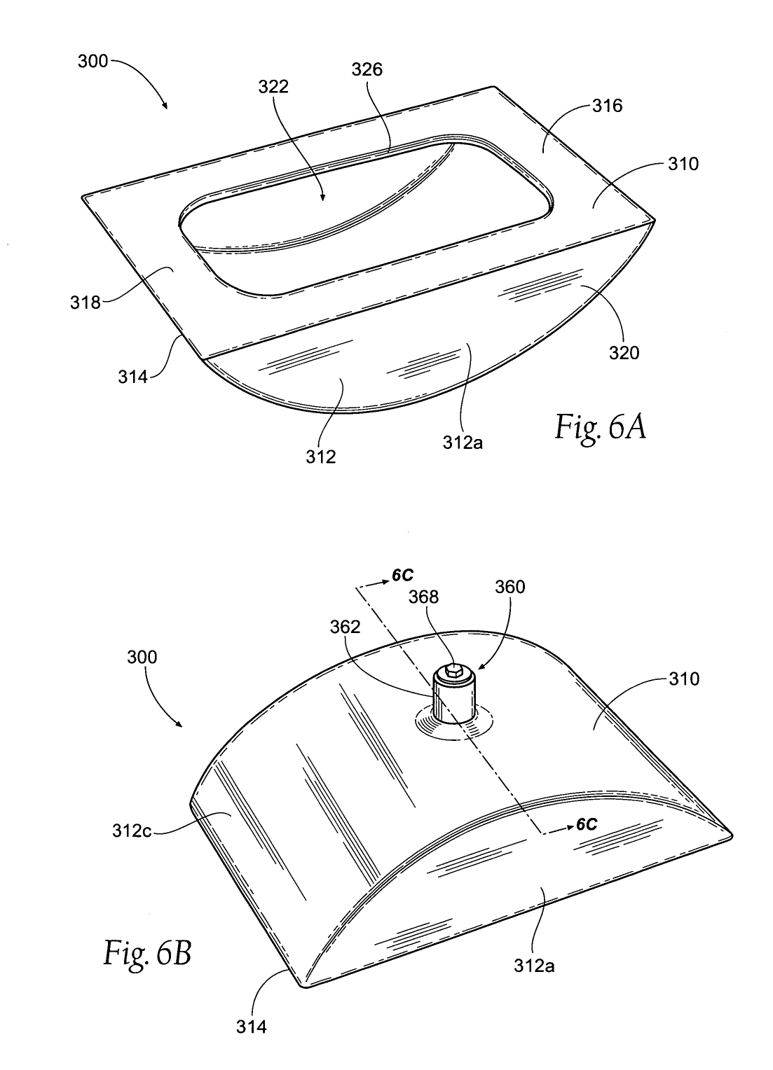

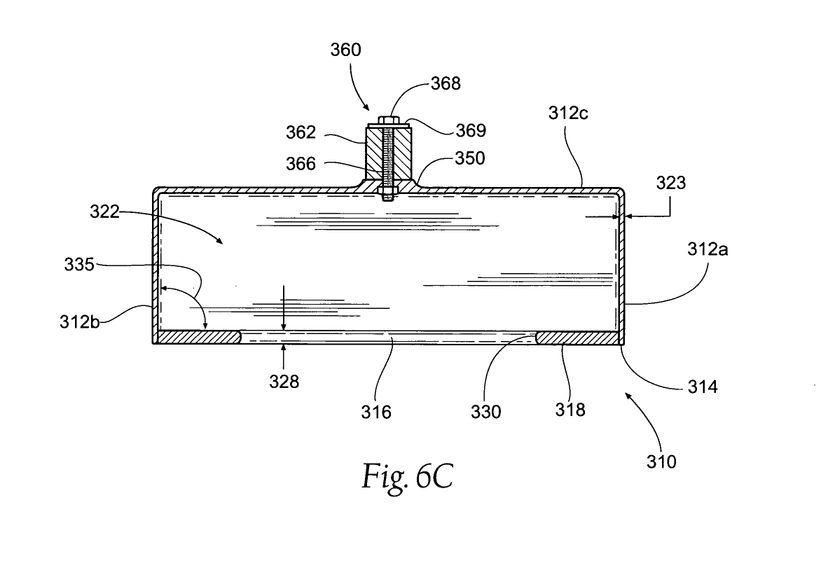

FIGS. 6A-6C depict a third embodiment 300 of a mold according to the present invention, wherein like reference numerals refer to similar or identical structure to that of the first two embodiments 100,200. The third preferred mold embodiment 300 generally includes a combination of the first embodiment 100 with the expandable mandrel 260 of the second embodiment 200. Thus, the exemplary embodiment 300 demonstrates that the extraction rim 116 may be used in a mold embodiment in combination with or without one or more expandable mandrels 260, and vice versa.

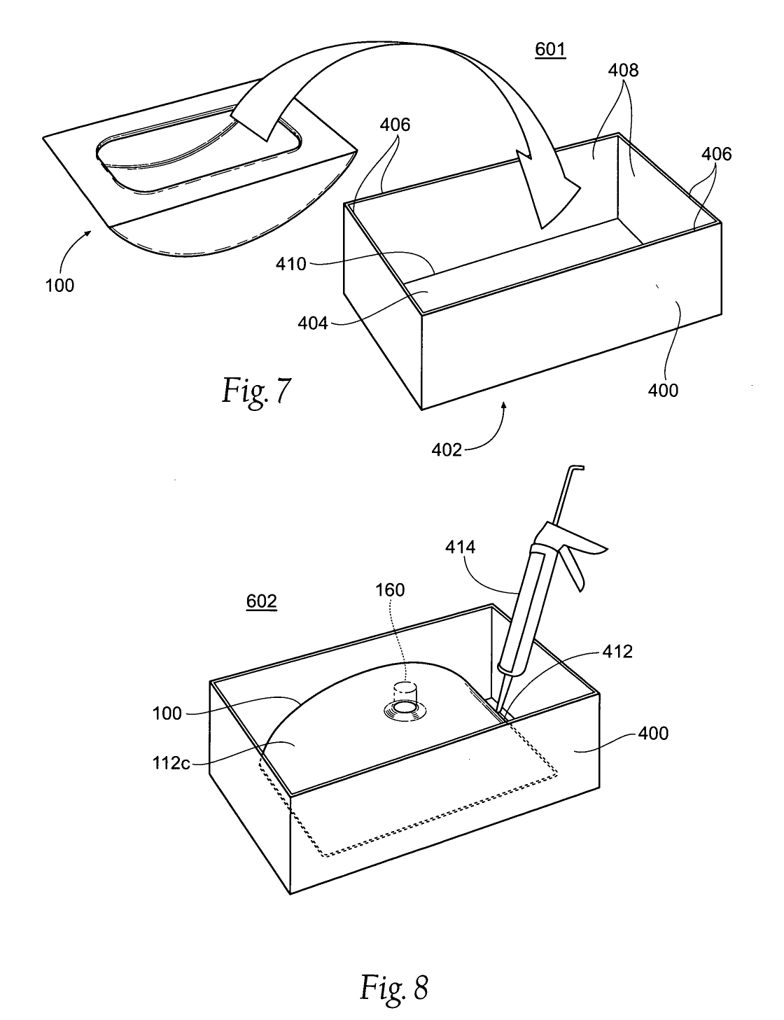

FIGS. 7-15 depict steps in a first method according to the present invention. In a first step 601, a mold 100 and a casting form 400 of a desired size and shape are provided. The casting form 400 may be a closed form type, such as that shown, having a bottom 402 including a molding surface 404, and side walls 406 having molding surfaces 408 that define a casting perimeter 410. Alternatively, the casting form 400 may include only the walls 406, without a bottom 402, which may be elevated above a second form (not shown) so as to allow the molding material, such as concrete, to flow through the casting form 400 and into the second form (not shown). The casting perimeter 410 is preferably larger than the outer perimeter 114 of the mold 100. As shown in FIG. 7, the mold 100 is placed in the casting form 400 on the molding surface 404, wherein the outer perimeter 114 of the mold 100 and/or the extraction rim 116 lie adjacent the molding surface 404. In a second step 602, as shown in FIG. 8, a bead 412 of caulk or sealant 414, preferably silicone caulk or sealant, may be applied at the junction of the outer perimeter 114 of the mold 100 and the molding surface 404 so as to prevent the seepage of the molding material under the mold 100. Additionally, void-forming mandrels 160 may be placed in desirable locations. Such mandrels 160 may include drain hole forming plugs or mandrels used to create plumbing or other passageways, for example.

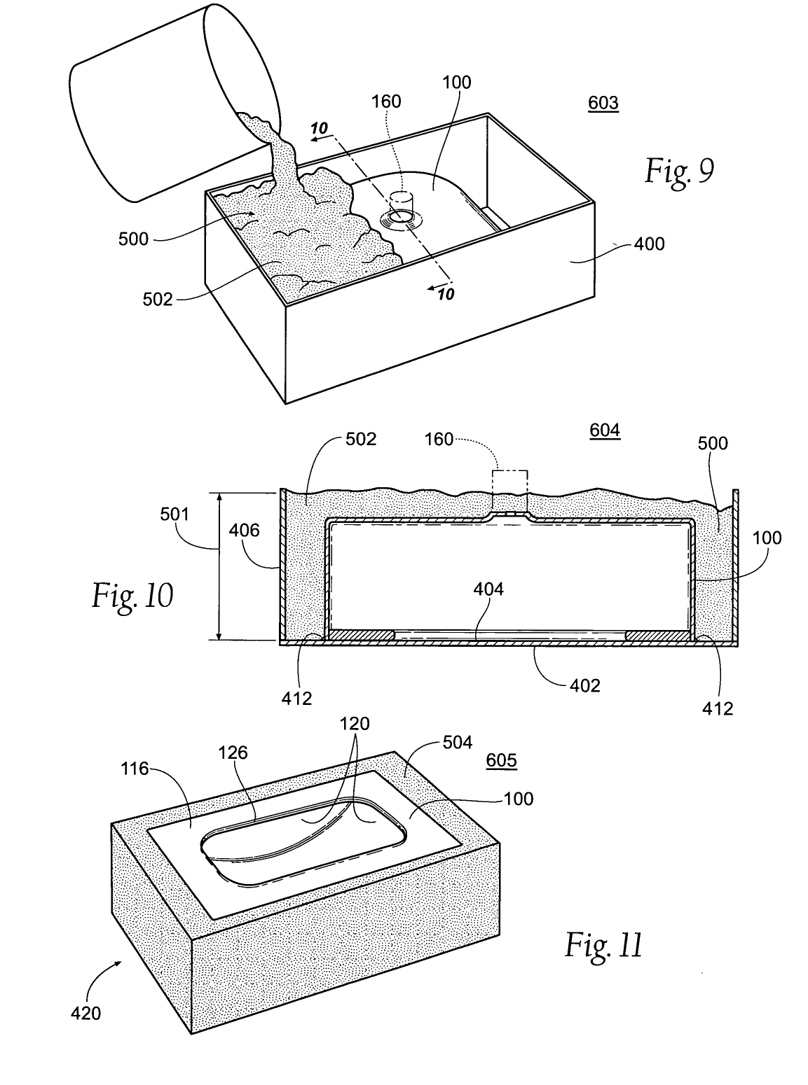

Once the silicone caulk bead 412 is sufficiently cured, molding material 500, such as concrete 502, is added to the casting form 400 at least partially over the mold 100, to a desired depth 501, as shown in FIGS. 9 and 10 in a third step 603. Preferably, prior to adding the molding material 500, a release agent is applied to the working surface(s) 112 of the mold 100 to assist in separating the mold 100 from a cured casting. The release agent may also be applied to the silicone caulk bead 412, as well as the bottom molding surface 404 of the casting form 400. Such release agents include barrier release agents, such as petroleum oils, water emulsions, waxes, or even soaps, as are known in the art. During or after the addition of molding material 500, the casting form 400 may be vibrated so as to cause the molding material 500 to settle, thereby attempting to rupture most if not all of any air pockets that may have been formed in the uncured molding material 500. In a fourth step 604, the molding material 500 is allowed to cure for a desired, perhaps predetermined amount of time, such as overnight.

In a fifth step 605, after the molding material 500 has cured for a desired or specified amount of time, an assembly combination 420 including the mold 100 and the cured molding material 500 in the form of a casting 504 may be removed from the casting form 400, or the casting form 400 may be removed from the assembly combination 420. If the casting form bottom 402 is removable from the casting form 400, the form 400 may be inverted and the bottom 402 removed, thereby exposing the at least one aperture 126 formed in the extraction plate 118. An example of a resulting assembly combination 420 may be seen in FIG. 11. At this point, it is desirable to separate the casting 504 from the mold 100 working surface(s) 112 to reveal a void (506 in FIG. 15) formed in the casting 504 thereby.

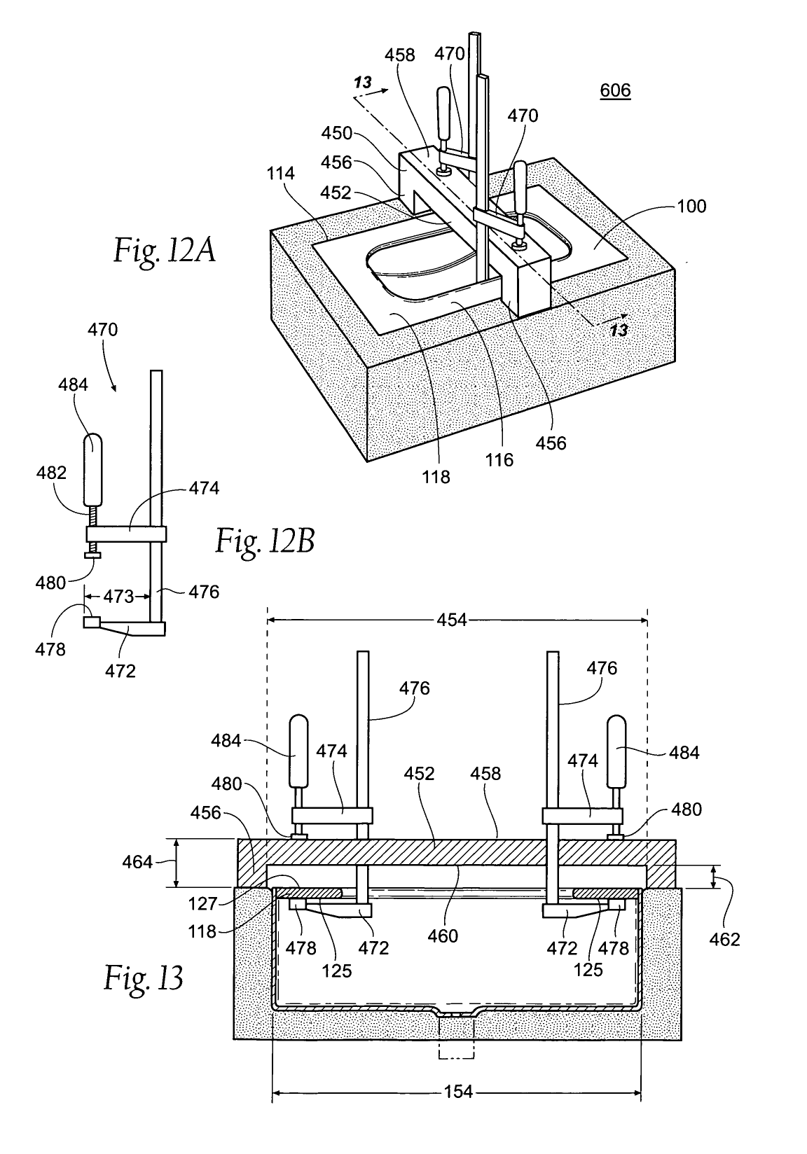

Turning now to FIGS. 12A-15, to remove the mold 100 from the assembly combination 420, an extraction bridge 450 is provided. The extraction bridge 450 preferably includes a span member 452 extending along a bridge gap length 454, and abutment portions 456 coupled to or formed integrally with the span member 452. The span member 452 has a top surface 458 and a bottom surface 460 which is oppositely disposed from the top surface 458. The abutment portions 456 extend away from the bottom surface 460 of the span member 452 along an abutment length 462. To extract the mold 100, the bridge 450 is placed so as to straddle the mold 100, the gap length 454 being preferably larger than the width 154 of the mold perimeter 114 at the location which the bridge 450 is situated. The bottom surface 460 of the span member 452 is spaced from the top surface 127 of the plate 118. At least one clamping member 470 is provided. A preferred clamping member 470 is depicted in FIG. 12B. The clamping member 470 includes a firs jaw member 472 and a second jaw member 474 disposed on a support beam 476. The first jaw member 472 is preferably stationarily fixed to the support beam 476, while the second jaw member 474 is preferably slidably disposed on the support beam 476. A first clamp contact pad 478 is provided by or coupled to the first jaw member 472. A clamping force applicator including a second clamp contact pad 480 is preferably coupled to the second jaw member 424. The force applicator further includes a threaded rod 482, which may threadably extend through the second jaw member 474, and may be swivelly coupled to the second clamp contact pad 480 at one end and fixedly coupled to a handle 484 at the other end. The first jaw member 472 includes a jaw depth 473 which is measured from the beam 476 to the tip of the first clamp contact pad 478.

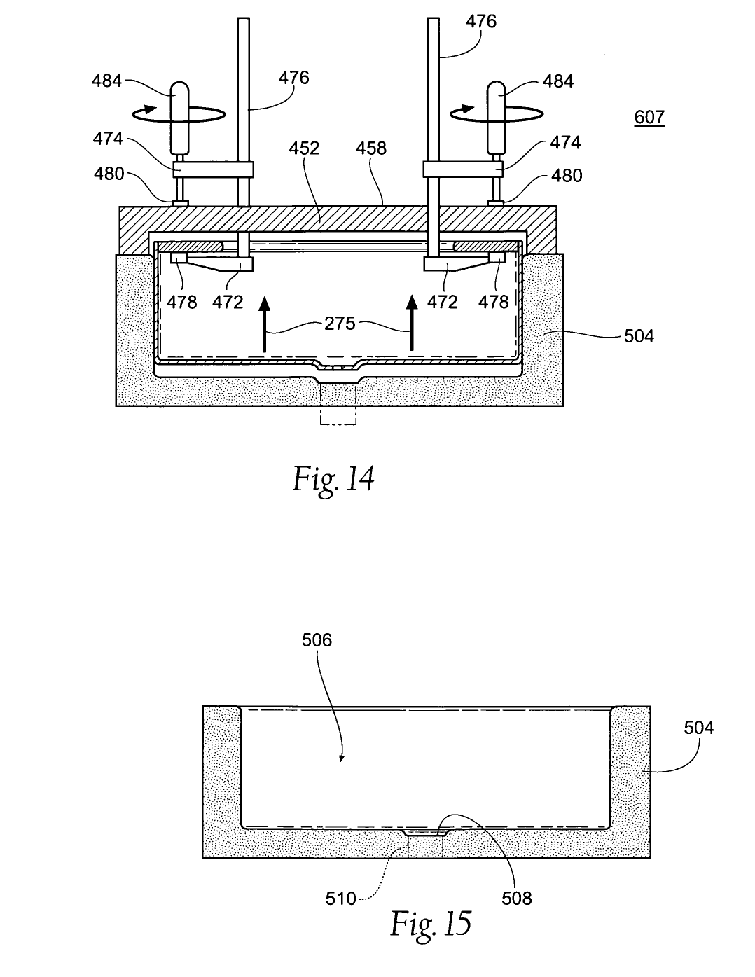

Returning now to FIG. 12A, in a sixth step in the method, the provided clamping members 470 may be arranged so that the first clamp contact pad 478 is in direct or indirect contact with the inner surface 125 of the plate 118 and the second clamp contact pad 480 is in direct or indirect contact with the upper surface 458 of the bridge span member 452. It is preferred to use at least one clamping member 470 on each side of the plate aperture 126 so that force can be applied to multiple points of the mold 100 simultaneously. Turning now to a seventh step 607 in the method, as shown in FIG. 14, the handles 484 of the clamping members 470 may be twisted so as to reduce the distance between the first clamp contact pad 478 and the second clamp contact pad 480. This, in turn, draws the plate 118 towards the bridge 450, eventually releasing the mold 100 from the casting 504. While the same amount of force may be applied by each clamping member 470, it is advantageous to allow the application of differing amounts of force. The mold/casting separation force is thought to be a function of the amount of surface area of the working surface 112 of the mold 100 which is exposed to the casting 504. If the asthetic design of the mold 100 provides for greater contact surface area between the mold 100 and the casting 504 at one location and less at another, the ability to provide differing amounts of force is advantageous to effect a relatively simultaneous, complete mold/casting separation. Where an annular extraction rim 116 is provided, one or more bridges 450 may straddle the mold 100 at various positions to allow 360 degree clamping capability. Furthermore, it may be advantageous to provide a maximum extraction rim width 129 which is less than or equal to the associated clamp jaw depth 473. This allows the first clamp contact pad 478 to be placed substantially anywhere on the inner surface 125 of the plate 118.

FIG. 15 depicts a casting 504 from which the mold 100 has been removed. The casting 504 may further include a drain indentation 508 formed by a protrusion 150 on the mold working surface 112c and may further include a drain aperture 510 formed by a mandrel 160.

In addition to the first extraction bridge 450, a second extraction bridge 490 may be provided. The second extraction bridge 490 may be used in conjunction with the first extraction bridge 450. The second extraction bridge 490, like the first 450, preferably includes a span member 492 extending along a bridge gap length 494, and abutment portions 496 coupled to or formed integrally with the span member 492. However, the abutment portions 496 may have a different abutment length 497 than the abutment length 457 of the first bridge 450, which may allow for overlapping of the bridges 450,490 in the event that simultaneous use of the multiple bridges is desired. The overlapping bridges may be arranged at any desirable angle with respect to each other. Alternatively, the bridges 450,490 may be used in a parallel arrangement.

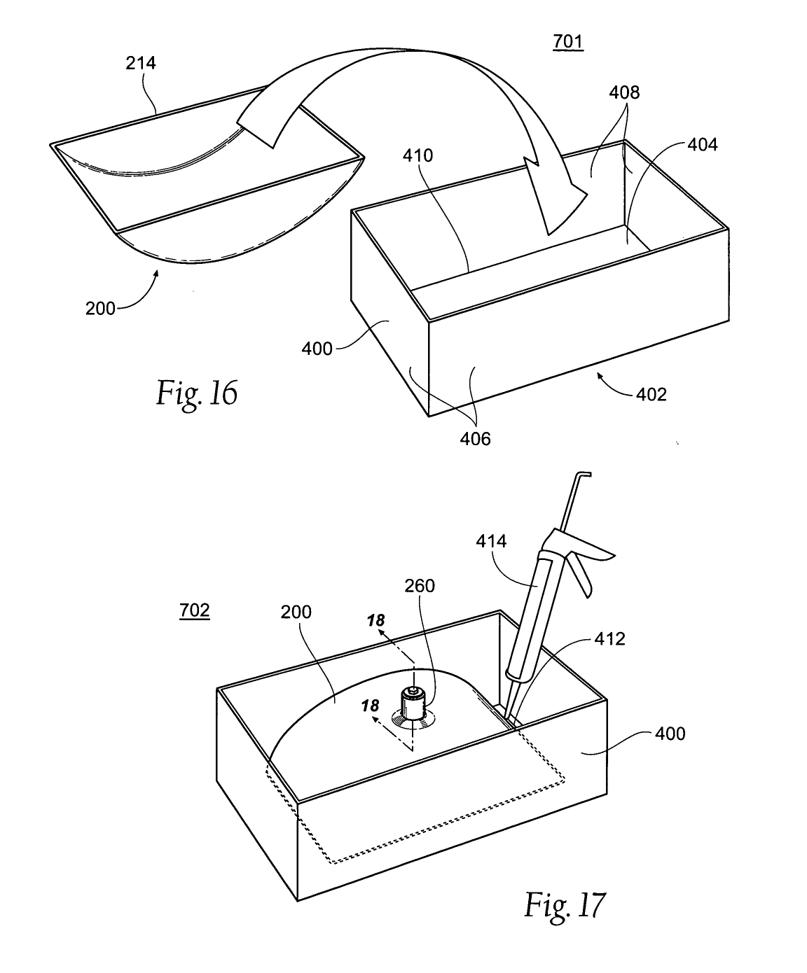

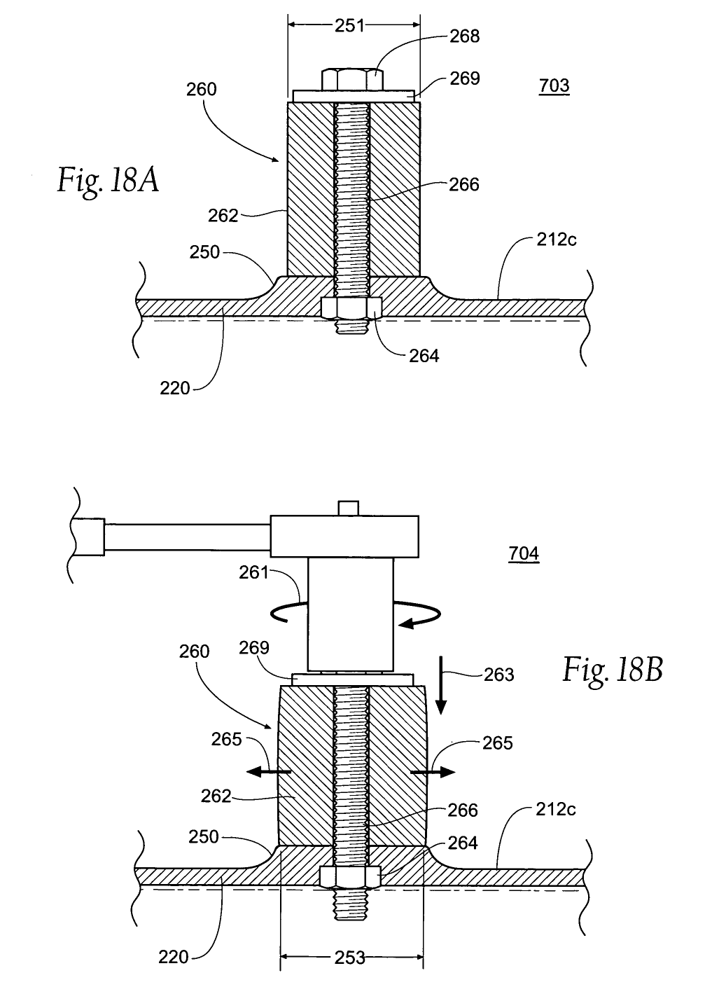

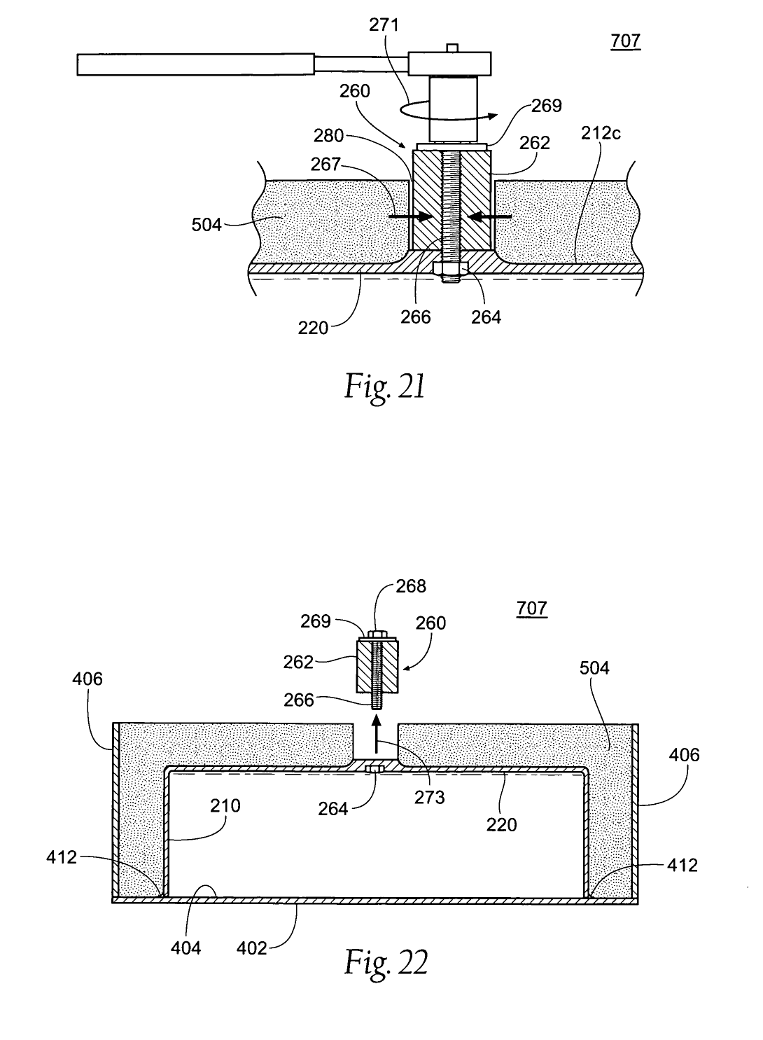

FIGS. 16-22 depict steps in a second method according to the present invention. In a first step 701, a mold 200 and a casting form 400 of a desired size and shape are provided. The casting form 400 may be a closed form type, such as that shown, having a bottom 402 including a molding surface 404, and side walls 406 having molding surfaces 408 that define a casting perimeter 410. Alternatively, the casting form 400 may include only the walls 406, without a bottom 402, which may be elevated above a second form (not shown) so as to allow the molding material, such as concrete, to flow through the casting form 400 and into the second form (not shown). The casting perimeter 410 is preferably larger than the outer perimeter 114 of the mold 200. As shown in FIG. 17, the mold 200 has been placed in the casting form 400 on the molding surface 404, wherein the outer perimeter 214 of the mold 200 and/or the extraction rim 216 lie adjacent the molding surface 404. In a second step 702, as shown in FIG. 17, a bead 412 of silicone caulk or sealant 414 may be applied at the junction of the outer perimeter 214 of the mold 200 and the molding surface 404 so as to prevent the seepage of the molding material under the mold 200. In a third step 703, a void-forming mandrel 260 is coupled, preferably removably coupled, to the mold housing 210, extending away from a working surface 212. Such mandrel 260 may include a drain-hole-forming plug, as shown, or mandrels used to create plumbing passageways, for example. The mandrel 260 is preferably a radially expandable mandrel which, in a fourth step 704, is expanded to an expanded state. The preferred embodiment, as described above in connection with FIGS. 4 and 5, includes a void-forming mandrel 260 which extends outward from a working surface 212c of the mold 200. The mandrel 260 is preferably a longitudinal body that is expandable in one or more radial directions 265. The mandrel 260 preferably includes an elastomeric bushing 262 that is removably coupled to the mold shell 220. In its free state, the bushing 262 has a first diameter or width 251. A threaded receiver nut 264 may cooperate with a threaded bolt 266 inserted through the bushing 262 to retain the mandrel 260 in an abutting relationship to the working surface 212c. The receiver nut 264 may be adhered to or formed integrally with the mold shell 220, or it may be provided as a separate component to rest against the inner surface 231 of the shell 220. The mandrel 260 further preferably includes a force distribution mechanism, such as a flat washer 269. Thus, to expand radially the mandrel 260, the threaded bolt 266 and nut 264 engagement is tightened. The tightening forces the washer 269 in a compression direction 263, thus expanding the bushing 262 radially outwardly 265 to a second diameter or width 253, which may be mated to other structure on the mold 200, such as a mating protrusion 250. The second diameter 253 is larger than the first diameter 251. This expansion step 704 is preferably performed prior to the fifth step 705, but it could be performed for some limited time thereafter, presuming the molding material 500 has not yet set.

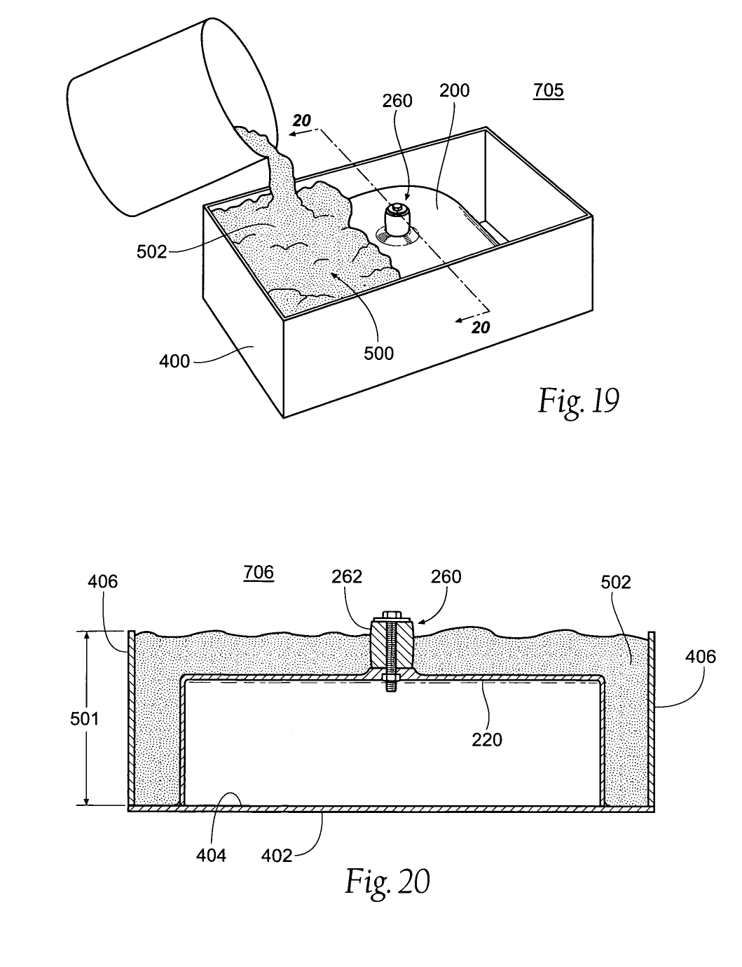

Once the silicone caulk bead 412 is sufficiently cured, molding material 500, such as concrete 502, is added to the casting form 400 over the mold 200, to a desired depth 501, as shown in FIGS. 19 and 20 in a fifth step 705. Preferably, prior to adding the molding material 500, a release agent is applied to the working surface(s) 212 of the mold 200 to assist in separating the mold 200 from a cured casting. The release agent may also be applied to the silicone caulk bead 412, as well as the bottom molding surface 404 of the casting form 400. Such release agents include barrier release agents, such as petroleum oils, water emulsions, waxes, or even soaps, as are known in the art. During or after the addition of molding material 500, the casting form 400 may be vibrated so as to cause the molding material 500 to settle, thereby attempting to rupture most if not all of any air pockets that may have been formed in the uncured molding material 500. In a sixth step 706, the molding material 500 is allowed to cure for a desired, perhaps predetermined amount of time, such as overnight.

After a predetermined or desired amount of time, a sixth step in the second method involves the decompression of the mandrel bushing 262. By loosening the threaded nut 264 and bolt 266 combination, the elastomeric bushing 262 is drawn in a radially inward direction 267, which is preferably at least substantially, if not completely, directly opposite to the expansion direction 265, due to its elastic properties. In this manner, a mandrel gap 280 is created between the mandrel bushing 262 and the cured casting 504. This gap 280 facilitates removal of the mandrel 260 prior to or contemporaneously with the removal of the mold housing 210.

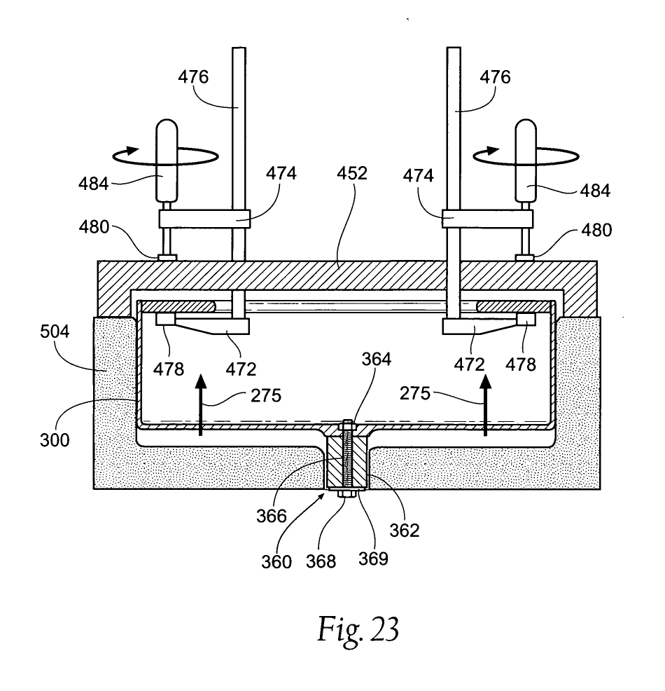

FIG. 23 depicts a third mold extraction method according to the present invention. The extraction method of FIG. 23 is a combination of the first and second extraction methods, where the decompression or removal of the mandrel 360 is performed prior to the clamping extraction.

It may be desirable to provide a mold according to the present invention in a kit form, i.e., all components in the same package or container, with one or more associated bridges 450, one or more associated mandrels 160,260,360, and/or at least one but preferably a plurality of clamping members 470. In this way, the user of such kit could be provided with various size mandrels and/or clamping members, and specific feature pairings or correlations could be made. As was described earlier, it may be desirable to correlate a maximum extraction rim width 129 to the jaw depth 473 of a clamping member to be used with such rim 116.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A mold comprising:
a housing formed partially around a cavity, said housing having at least one working surface adapted to receive a molding material, wherein said working surface defines a mold perimeter, and said housing further having an extraction rim extending radially inward from said mold perimeter.

2. A mold according to claim 1, wherein said extraction rim comprises a substantially planar plate.

3. A mold according to claim 2, wherein said plate completely surrounds at least one aperture formed through said plate.

4. A mold according to claim 1, further comprising a void-forming mandrel coupled to said housing adjacent to and extending away from one of said at least one working surface.

5. A mold according to claim 4, wherein said void-forming mandrel is detachably coupled to said housing.

6. A mold according to claim 5, wherein said void-forming mandrel comprises a radially expansible member.

7. A mold according to claim 6, wherein said radially expansible member comprises an elastomeric bushing.

8. A mold according to claim 7, wherein said elastomeric bushing comprises polyurethane rubber having a predetermined hardness.

9. A mold according to claim 8, wherein said predetermined hardness is about 30 Shore.

10. A mold kit comprising:
a mold comprising:
a housing formed partially around a cavity, said housing having at least one working surface adapted to receive a molding material, wherein said working surface defines a mold perimeter, and said housing further having an extraction rim extending radially inward from said mold perimeter, said extraction rim having a maximum width,
wherein said extraction rim comprises a substantially planar plate and said plate completely surrounds at least one aperture formed through said plate; and
a first extraction bridge adapted to span a first portion of said mold perimeter.

11. A mold kit according to claim 12, further comprising at least one clamping member.

12. A mold kit according to claim 11, wherein said at least one clamping member comprises:
a support beam;
a first jaw member fixed to one end of said support beam;
a second jaw member slidably disposed on said support beam; and
a clamping force applicator disposed at least partially between said first jaw member and said second jaw member.

13. A mold kit according to claim 12, further comprising a first clamp contact pad disposed on said first jaw member, wherein all points of said first clamp contact pad are located at a jaw depth that is less than or equal to said maximum width of said extraction rim.

14. A mold kit according to claim 13, wherein said clamping force applicator comprises a threaded rod extending through one of said jaw members.

15. A mold kit according to claim 14, wherein said threaded rod extends through said second jaw member.

16. A mold kit according to claim 10, further comprising a second extraction bridge adapted to span a second portion of said mold perimeter.

17. A mold kit according to claim 16, wherein said first extraction bridge and said second extraction bridge are adapted to function in an overlapping relationship to each other.

18. A mold kit according to claim 10, wherein said first portion of said mold perimeter comprises a diameter of said mold perimeter.

19. A method of molding, said method comprising the steps of:
providing a mold having a housing formed partially around a cavity, said housing having at least one working surface adapted to receive a molding material, wherein said working surface defines a mold perimeter, and said housing further having an extraction rim extending radially inward from said mold perimeter,
wherein said extraction rim comprises a substantially planar plate and said plate completely surrounds at least one aperture formed through said plate;
providing a mold extraction bridge;
disposing a casting material on said working surface;
curing said casting material to form an assembly combination comprising said mold and said casting material; and
removing said mold from said casting material using said extraction rim and said mold extraction bridge.

20. A method according to claim 19, wherein said removing step comprises steps of:
spanning a portion of said mold perimeter with said mold extraction bridge;
interfacing a clamping member to said extraction bridge and said extraction rim; and
drawing said extraction rim towards said extraction bridge using said clamping member.
